(19) United States
(12) Patent Application Publication
(10) Pub. No.: US 2009/0049152 A1
(43) Pub. Date: Feb. 19, 2009

(54) Method and Apparatus for Collecting Performance Management Data in Communication Networks

(75) Inventors: Anna Pucar Rimhagen, Motala (SE); John Quilty, Athlone (IE); Erik Lars Westerberg, Enskede (SE)

Correspondence Address: COATS & BENNETT, PLLC, 1400 Crescent Green, Suite 300, Cary, NC, 27518, US

(73) Assignee: Telefonaktiebolaget LM Ericsson (publ), Stockholm (SE)

(21) Appl. No.: 12/022,646

(22) Filed: Jan. 30, 2008

Related U.S. Application Data
(60) Provisional application No. 60/956,199, filed on Aug. 16, 2007.

(51) Int. Cl. G06F 15/16

(52) U.S. Cl. 709/209

(57) ABSTRACT

Nodes such as base stations in a mobile communication network are divided and grouped into management clusters. One of the nodes in each management cluster is selected to be a master node. The master node aggregates performance data for each of the nodes in its assigned cluster, and sends a consolidated performance management report containing the aggregated data to a management entity.

### RELATED APPLICATIONS

This application claims priority from U.S. Provisional Application Ser. No. 60/956,199 entitled “Master RBS for PM File Collection.” That application was filed on Aug. 16, 2007 and is incorporated herein by reference in its entirety.

### TECHNICAL FIELD

The present invention relates generally to communications networks, and particularly to communication networks that collect performance data from one or more network elements.

### BACKGROUND

Currently, most network elements (NEs) such as Radio Base Stations (RBSs), for example, regularly produce performance management (PM) files. PM files contain data such as statistical information and historical logs that indicate a NEs performance in the network. Generally, each NE collects its own performance data for transmission to a common Domain Manager (DM). In some networks, the DM collects the PM files from each NE, while in other networks, the individual NEs “push” their PM files to the DM. Once collected, network operators can use this information to troubleshoot the network, determine its performance, and alter the operation of the network as necessary.

For some newer types of communication networks, the costs of producing PM files can be significantly higher than it is for conventional communication networks. Long Term Evolution (LTE) networks are an example of such a network. LTE networks employ a flat, packet only, all-IP based architecture that connects all RBSs directly to a DM. Because of this flat architecture, the number of NEs generating PM files is considerably higher than it is for other networks that do not employ a flat architecture. Therefore, the DM in an LTE network can experience a greater processing load when collecting PM files than will a DM in these other networks.

For example, a Wideband Code Division Multiple Access (W-CDMA) network typically collects performance information from a relatively few Radio Network Controllers (RNCs), each of which may be connected to hundreds of RBS that generate their own PM files. Collecting the performance information from each of the RNCs is critical because failing to collect the information from even a single RNC leaves a large “hole” in the network observations. This could negatively affect a network operator's ability to troubleshoot and manage the network. Thus, collection mechanisms in W-CDMA networks must be able to reliably collect information from a relatively few RNCs.

LTE networks, however, are different because there are no RNCs to collect the performance data. In an LTE network, the DM would directly connect to each RBS, which could number in the thousands. Therefore, it is critical for the DM to reliably collect a large number of PM files in a relatively short period of time to prevent leaving the network operator with such “holes.”

It will be more difficult for a DM in an LTE network to cope with collecting all the PM files directly from each RBS. Further, each PM file generated by a RBS in an LTE network will contain less data than PM files generated in W-CDMA networks. As such, the percentage of overhead information per PM file will increase dramatically.

### SUMMARY

The present invention provides a method of collecting performance data from a plurality of nodes in a communication network. In one embodiment, the nodes are divided and grouped to form management clusters. One of the nodes in each of the management clusters is selected to be a master node. The master node aggregates performance data for all nodes in its assigned cluster, and sends a consolidated management report containing the aggregated data to a management entity.

### BRIEF DESCRIPTION OF THE DRAWINGS

FIG. 1 illustrates an exemplary communications network suitable for use in one embodiment of the present invention.

FIG. 2 is a block diagram that illustrates a conventional communication network without a management overlay.

FIG. 3 is a block diagram that illustrates a communication network with a management overlay according to one embodiment of the present invention.

FIG. 4 illustrates an aggregation function for aggregating Performance Management files at a master node according to one embodiment of the present invention.

FIG. 5 is a block diagram that illustrates some of the components of a master node in a management cluster configured according to one embodiment of the present invention.

FIG. 6 is a block diagram that illustrates another embodiment to the present invention.

### DETAILED DESCRIPTION

The present invention provides a method and apparatus for collecting and reporting aggregated performance data to a centralized network entity. Network operators, for example, can use the aggregated performance data to troubleshoot the network, monitor network performance, and alter the operation of the network as necessary.

In one embodiment, an LTE communication network comprises a plurality of Radio Base Stations (RBSs), which are referred to as eNodeBs. Each eNodeB monitors and collects information indicative of its performance in the LTE network. The eNodeBs in the network are divided and grouped into one or more management clusters. One of the eNodeBs in each management cluster is selected to be a master eNodeB. The master eNodeB collects the individual performance data from each of the eNodeBs in its cluster, aggregates the information to generate a composite performance report, and sends the composite report to a Domain Manager (DM).

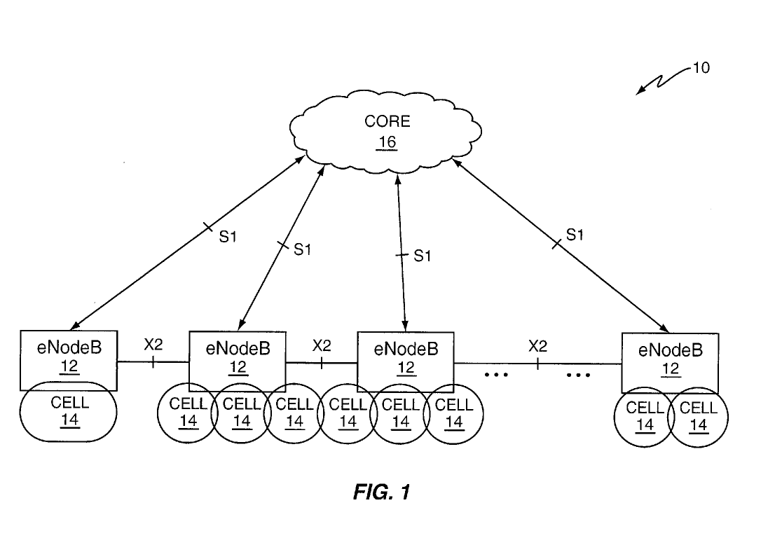

FIG. 1 illustrates an overview of an LTE Radio Access Network (RAN) 10 with its nodes and interfaces. The architecture of the LTE RAN 10 is well known in the art, and thus, not described in detail here. However, a brief description of the LTE RAN 10, its nodes, and its interfaces, is included herein for clarity.

The LTE RAN 10 includes only one type of node—the eNodeB 12. Each eNodeB 12 serves mobile terminals (not shown) in one or more cells 14. In operation, the eNodeB 12 performs the typical physical-layer functions required for communication with the mobile terminals. Such functions include, but are not limited to, encoding/decoding, modulation/demodulation, and interleaving/de-interleaving. In addition, the eNodeB 12 also performs the classical Radio Network Controller (RNC) functions, and therefore, effects decisions regarding handover, radio resource allocation, and scheduling decisions for both uplink and downlink communications.

Each eNodeB 12 connects to the Core Network (CORE) 16 via an S1 interface. Generally, the CORE 16 is sometimes referred to as the Evolved Packet Core (EPC.

The S1 interface that connects each eNodeB 12 to CORE 16 is IP-based. The S1 interface carries both user traffic and signaling data between eNodeB 12 and CORE 16, and is similar to the Iu communication interface in an W-CDMA/HSPA network. An X2 communication interface connects each eNodeB 12 to another eNodeB 12 in a neighboring cell. Generally, the X2 interface carries signaling data to support active-mode mobility, but may also convey signaling, and Operations and Management (O&M) data to support radio resource management functions between the cells 14.

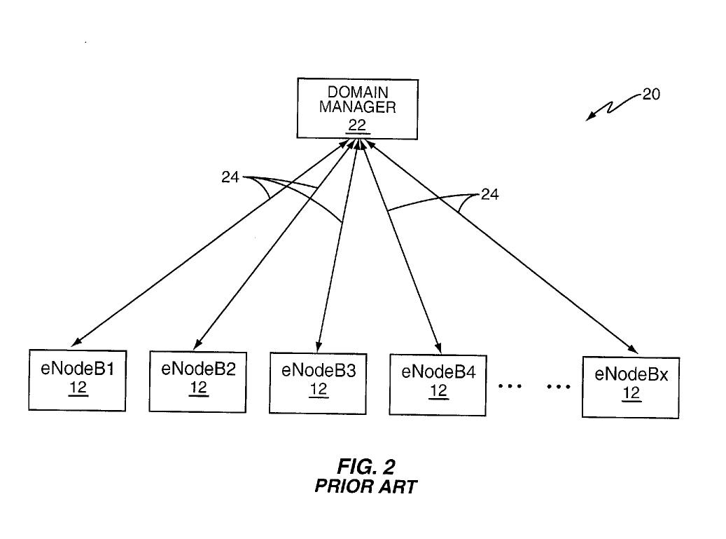

As previously stated, most network elements regularly generate performance management files (PM files) that contain performance information that network operators may use to monitor system performance. FIG. 2 is a block diagram that illustrates an architecture by which a conventional LTE network may collect these PM files from a plurality of eNodeBs 12.

As seen in FIG. 2, each eNodeB 12 connects to a common Domain Manager (DM) 22 via a communication link 24. In general, each eNodeB 12 collects its own performance data, and generates one or more PM files for transmission it to the DM 22. In some LTE networks, the DM 22 collects the PM files from each eNodeB 12, while in other networks, the individual eNodeBs 12 “push” their PM files to the DM 22. Once collected, network operators can use this information to troubleshoot the network, determine its performance, and alter the operation of the network as necessary.

Because LTE networks employ a flat architecture, each eNodeB 12 connects directly to the common DM 22 over its own link 24. There may be a high number of eNodeBs 12 generating performance information, and thus, the DM 22 in an LTE network must be able to handle a potentially large number of communication links 24. Additionally, a greater number of eNodeBs 12 would produce a larger number of PM files. Therefore, this would mean a dramatic increase in the percentage of overhead information provided to the DM 22. Further, because the DM 22 typically aggregates this information in LTE networks, the DM 22 must be able to handle a greater processing load. As such, the cost of producing PM files in LTE networks can be significantly higher than it is for other types of wireless networks.

The present invention, however, addresses these issues by collecting and aggregating a plurality of PM files generated by a plurality of eNodesBs 12 into a composite PM file. This composite PM file is then sent to DM 22.

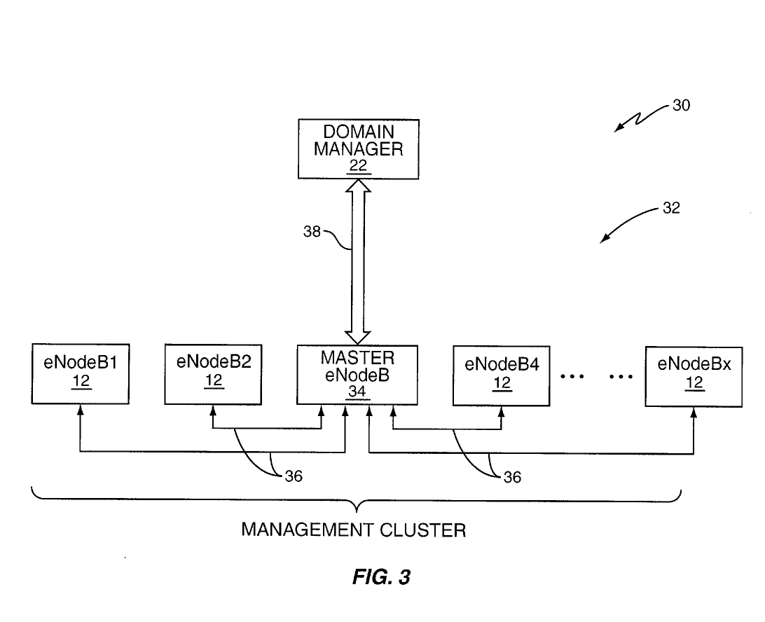

FIG. 3 is a block diagram that illustrates an LTE network architecture 30 having a management overlay according to one embodiment of the present invention. As seen in FIG. 3, the management overlay groups a plurality of eNodeBs 12 to form a management cluster 32. One of the eNodeBs 12 is selected to be a master node 34 for the management cluster. The master node 34 connects to each of the other eNodeBs 12 in the cluster 32 via a sidehaul link 36. The sidehaul links 36 may be any communication interface known in the art; however, in one embodiment, each sidehaul link 36 comprises an X2 interface. There is typically one sidehaul link 36 between the master node 34 and each eNodeB 12.

Generally, the master node 34 supports enhanced operations and management (O&M) functionality, and functions to aggregate and control the O&M functionality within the cluster. According to one embodiment of the present invention, each eNodeB 12 in the cluster 32 monitors its own performance and generates one or more of its own PM files. Likewise, the master node 34 also generates its own PM files. The type of information may be any information desired; however, in one embodiment, each eNodeB 12, 34 in the management cluster 32 collects and groups its performance data into the following files.
Counters
Events
User Equipment (UE) Trace
Cell Trace
   As those skilled in the art will appreciate, this list is illustrative. Each eNodeB 12, 34 in the management cluster 32 may collect other information for inclusion in other files not specifically mentioned here as needed or desired.

The master node 34 collects these individual PM files over the respective sidehaul links 36. The master node 34 then merges the received information and data in each of the collected individual PM files to generate one or more composite PM files. The composite PM files generated by the master node 34 are then sent to the DM 22 over a communication link 38.

It should be noted that in some embodiments, the master node 34 employs a compression technology, such as Z or WINZIP, for example, to compress the composite PM files prior to transmitting them to DM 22. The master node 34 then sends the compressed data to DM 22 using the File Transfer Protocol (FTP), or in a message formatted according to a Simple Object Access Protocol (SOAP). Other types of transmission methods and protocols are also suitable.

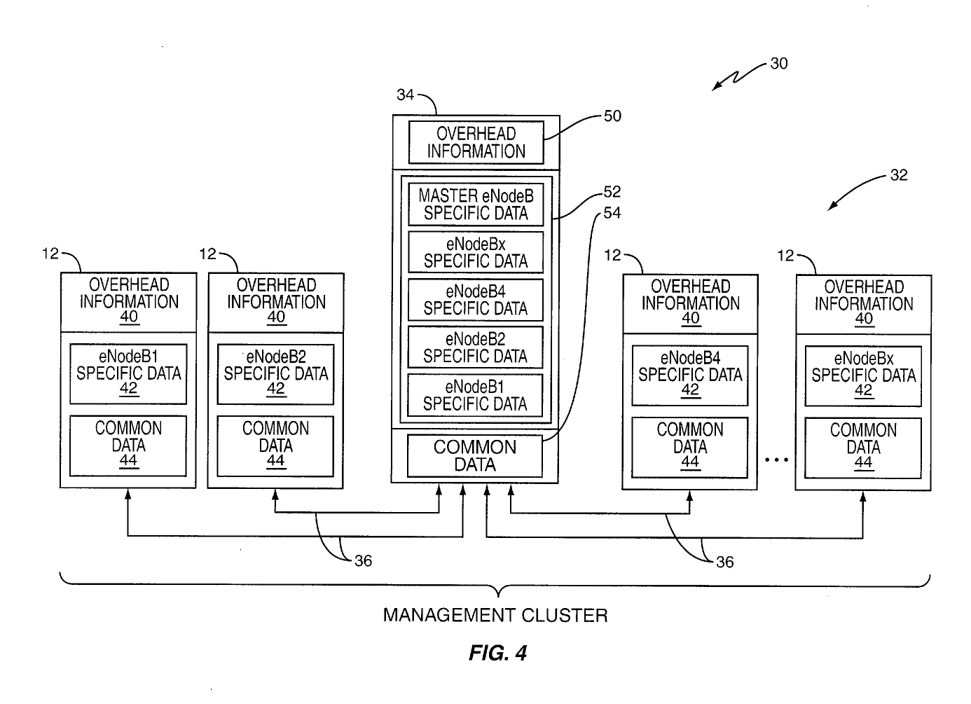

FIG. 4 is a block diagram that illustrates how the master node 34 collects and aggregates the individual PM files from each eNodeB 12 in the management cluster 32. For clarity, only a single eNodeB 12 is referenced; however, those skilled in the art will readily appreciate that the following discussion applies to each of the eNodeBs 12 in the cluster 32.

As seen in FIG. 4, each eNodeB 12 collects its performance information and produces one or more PM files. The master node 34 also collects its own data and produces one or more PM files. The data includes, but is not limited to, information and data such as overhead information 40, data specific to the particular eNodeB 12 42, and common data 44. These files 40, 42, 44 are then sent from each eNodeB 12 to the master node 34.

In this embodiment, each eNodeB 12 and master node 34 is shown producing a plurality of PM files. However, this is for illustrative purposes only. Depending on implementation, each eNodeB 12 and/or master node 34 may collect, store, and send all of its information in a single PM file, or a plurality of PM files as needed or desired.

Upon receipt, the master node 34 reads the files and aggregates similar data into one or more composite PM files. In this embodiment, for example, the master node 34 compiles the individual PM files into a plurality of composite PM files 50, 52, 54. For example, a first composite file 52 may be generated to include all the overhead information received from each of the other eNodeBs 12, while a second composite PM file may be generated to include the data specific to each eNodeB 12. A third composite file 54 may include the aggregated data common to each of the other eNodeBs 12. In other embodiments, the master node 34 may compile all of this information into a single PM file. Once compiled, the master node 34 sends the composite files to DM 22 over link 38.

The present invention significantly reduces the number of files that the DM 22 must handle. This can result in an increased performance throughout the LTE network. Table 1, for example, illustrates some of the benefits by comparing the number of files that DM 22 must handle for a single cluster using the present invention to the number of files that DM 22 must handle using a more conventional method of data collection. The following assumptions apply:
Number of eNodeBs in a cluster: 200
Total number of eNodeBs supported by a single DM: 5,000
Number of files generate per eNodeB: 4 (1 for counters, 1 for events, 1 for cell trace, 1 for UE trace)
Typical file size: 10 kB
Typical size of the overhead information per file: 1 kB
Typical size of the common information per file (counter names, time stamps, etc): 1 kB

TABLE 1
Comparison of networks with and without management overly

| | # files to | # files to | Amount of | % overhead/ |
|---|---|---|---|---|
| | collect/cluster | collect, total | data, total | useful data |
| Without | 800 | 20 000 | 200 MB | 10% |
| Master | | | | |
| eNodeB | | | | |
| With Master | 4 | 100 | 160 MB | 0.05% |
| eNodeB | | | | |

As seen in Table 1, the use of the management overlay to aggregate and compile composite PM files prior to transmission to the DM 22 significantly reduces the number of files that the DM 22 must handle. This reduces the processing load at the DM 22. In addition, the present invention also facilitates increased bandwidth savings in the transport network. Particularly, the overhead data and the common data will only be sent once per cluster with the present invention. Thus, the amount of information being transmitted to DM 22 is greatly reduced. Further, this mitigates possible problems due to limitations on the number of mainstream server OSs, and to communication protocols that limit the number of concurrent links that may be opened to the eNodeBs 12.

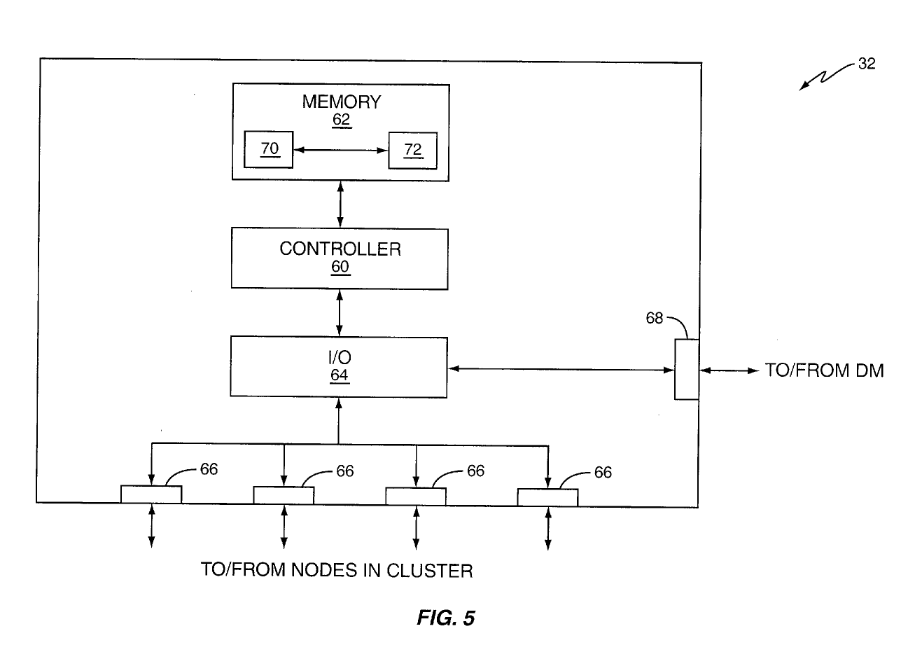

FIG. 5 is a block diagram that illustrates some of the components of a master node 34 configured according to one embodiment of the present invention. The master node 34 may be any network entity known in the art. In one embodiment, the master node 34, and each of the eNodeBs 12 in cluster 32, comprise RBSs that communicate with one or more mobile terminals via an air interface. However, those skilled in the art will appreciate that other network entities are also suitable for use with the present invention.

As seen in FIG. 5, the master node 34 comprises a controller 60, memory 62, an Input/Output (I/O) circuit 64, communication ports 66 to communicate with the other eNodeBs 12 in the cluster 32, and a communication port 68 to communicate the composite PM files to the DM 22.

Controller 60 comprises one or more microprocessors that control the operation of the master node 34 according to program instructions and data stored in memory 62. The control functions may be implemented in a single microprocessor, or in multiple microprocessors. Memory 62 may include both random access memory (RAM) and read-only memory (ROM). Executable program instructions and data required for operation of the master node 34 are stored in non-volatile memory, such as EPROM, EEPROM, and/or flash memory, and may be implemented as discrete or stacked devices, for example.

Communication ports 66 are configured to communicate data with the other eNodeBs 12 in management cluster 32 via the sidehaul links 36. In this embodiment, the master node 34 includes one port 66 for each eNodeB 12 in the cluster 32. However, the illustration is for clarity only. The master node 34 may have other communication port configurations to connect to the eNodeBs 12 in cluster 32. The master node 34 receives the PM files generated by the individual eNodeBs 12 via the ports 66. In some embodiments, the master node 34 also sends requests over ports 66 to the eNodeBs 12 in cluster 32 to send the PM files for aggregation. Once the PM files are aggregated, the master node 34 sends the composite PM files to the DM 22 via port 68.

In one embodiment, the memory 62 stores an application program 70. Application program 70 includes logic and instructions that cause controller 60 to request the individual PM files from the eNodeBs 12 in the cluster 32, and to receive those files. Application program 70 also includes instructions that cause controller 60 to generate the composite PM files 72 using the received information.

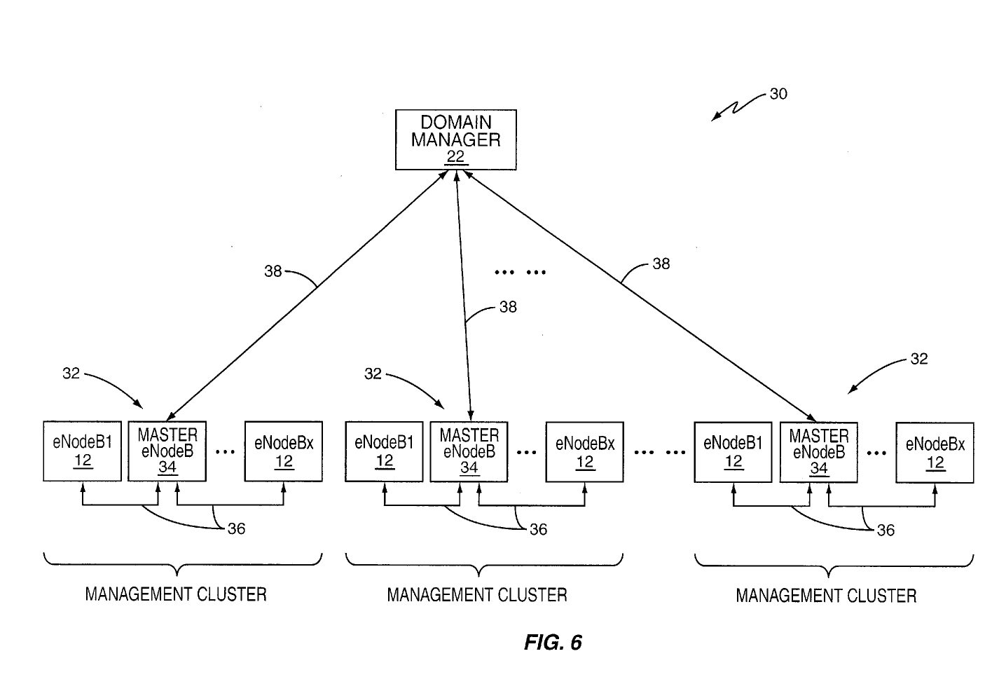

Although the previous embodiments illustrate the present invention in terms of a single management cluster 32, those skilled in the art should appreciate that this is for illustrative purposes only. The present invention is not limited to a single DM 22 supporting a single management cluster 32. FIG. 6, for example, illustrates an embodiment wherein a single DM 22 supports a plurality of management clusters 32. In FIG. 6, each cluster 32 includes a plurality of interconnected eNodeBs 12 and a master node 34. Each master node 34 is connected to the DM 22 via a communication link 38. The master nodes 34 in FIG. 6 are configured to collect and aggregate PM files received from each of the eNodeBs 12 in their respective clusters 32, and send those composite files to the DM 22 as previously described.

The previous embodiments describe the one or more composite files sent to the DM 22 as including information generated by the individual eNodeBs 12 as well as the master node 34. Additionally, however, the one or more composite files may also include information not generated by the individual eNodeBs 12 and/or the master node 34. For example, in one embodiment, the master node 34 generates one or more composite files to identify information or data that is missing, such as whether a given eNodeB failed to report some or all of its collected performance information. In another embodiment, the composite files include extra information, or information that was missing from a previous reporting period. In all cases, the composite reports may identify which eNodeBs 12 sent/did not send their one or more PM files.

Further, the DM 22 is not required to wait until a predetermined report time to collect the PM files. Rather, the DM 22 can query the master node 34 to determine the status of the information, or to obtain the information at any time independently of the composite files it receives.

The present invention may, of course, be carried out in other ways than those specifically set forth herein without departing from essential characteristics of the invention. Therefore, the present embodiments are to be considered in all respects as illustrative and not restrictive, and all changes coming within the meaning and equivalency range of the appended claims are intended to be embraced therein.

What is claimed is:

1. A method of sending performance data to a management entity in a mobile communication network, the method comprising:
forming a management cluster comprising a plurality of peer nodes;
selecting a peer node in the management cluster to be a master node;
aggregating performance data for multiple peer nodes in the management cluster by the master node; and
sending a performance report containing the aggregated performance data from the master node to the management entity.

2. The method of claim 1 further comprising:
connecting the master node to each of the other peer nodes in the management cluster using a corresponding first communication link; and
connecting the master node to the management entity using a second communication link.

3. The method of claim 2 further comprising receiving the performance data at the master node from one or more of the other peer nodes in the management cluster over respective first communication links.

4. The method of claim 2 wherein sending a performance report containing the aggregated performance data comprises sending the performance report from the master node to the management entity via the second communication link.

5. The method of claim 1 wherein aggregating performance data for multiple peer nodes in the management cluster comprises generating the performance report to include data common to each of the peer nodes in the management cluster.

6. The method of claim 5 wherein aggregating performance data for multiple peer nodes in the management cluster comprises generating the performance report to include node-specific data sent by one or more of the peer nodes in the management cluster.

7. The method of claim 6 wherein aggregating performance data for multiple peer nodes in the management cluster comprises generating the performance report to include overhead data sent by one or more of the peer nodes in the management cluster.

8. The method of claim 1 further comprising receiving the performance data from one or more of the other peer nodes in the management cluster.

9. The method of claim 8 further comprising:
generating a request to obtain the performance data from each of the other peer nodes in the management cluster;
sending the request to each of the other peer nodes in the management cluster; and
receiving the requested performance data from one or more of the other peer nodes in the management cluster responsive to the request.

10. The method of claim 1 wherein sending the performance report to the management entity comprises:
receiving a request from the management entity to send the performance report having the aggregated performance data; and
transmitting the performance report to the management entity.

11. A node for sending performance data to a management entity in a mobile communication network, the node comprising:
a first communication interface configured to receive performance data from multiple peer nodes in a management cluster;
a second communication interface to send a performance report to a management entity; and
a controller configured to:
generate the performance report by aggregating the performance data received from the multiple peer nodes over the first communication interface; and
send the performance report to the management entity over the second communication interface.

12. The node of claim 11 wherein the first communication interface comprises a plurality of first communication links, each first communication link connecting the node to one of the multiple peer nodes in the management cluster.

13. The node of claim 12 wherein the controller is configured to receive the performance data from the multiple peer nodes over respective first communication links.

14. The node of claim 12 wherein the second communication interface comprises a communication link that connects the node to the management entity.

15. The node of claim 11 wherein the node comprises a master node selected from the multiple peer nodes in the management cluster.

16. The node of claim 15 wherein the master node comprises an eNodeB in a Long Term Evolution (LTE) communication network.

17. The node of claim 11 wherein the controller is configured to generate the performance report to include data common to each of the multiple peer nodes in the management cluster.

18. The node of claim 11 wherein the controller is configured to generate the performance report to include node-specific data sent by one or more of the multiple peer nodes in the management cluster.

19. The node of claim 11 wherein the controller is configured to generate the performance report to include overhead data sent by one or more of the multiple peer nodes in the management cluster.

20. The node of claim 11 wherein the controller is configured to:
generate a request for the performance data from each of the peer nodes in the management cluster;
send the request to each of the peer nodes in the management cluster; and
receive the requested performance data from one or more of the peer nodes in the management cluster responsive to the request.

21. The node of claim 11 wherein the controller is configured to:
receive a request from the management entity for the performance report; and
transmit the performance report to the management entity responsive to the received request.

22. The node of claim 11 further comprising an application module stored in a memory of the node, and configured to cause the controller to aggregate the performance data to generate the performance report.
